(19) United States
(12) Patent Application Publication
(10) Pub. No.: US 2010/0020438 A1
(43) Pub. Date: Jan. 28, 2010

(54) MULTI-DIMENSIONAL HARD DISK DRIVE VIBRATION MITIGATION

(75) Inventors: Kenny C. Gross, San Diego, CA (US); Anton Bougaev, La Jolla, CA (US); Aleksey M. Urmanov, San Diego, CA (US); David K. McElfresh, San Diego, CA (US)

Correspondence Address: PVF -- SUN MICROSYSTEMS INC.;C/O PARK, VAUGHAN & FLEMING LLP, 2820 FIFTH STREET, DAVIS, CA, 95618-7759, US

(73) Assignee: Sun Microsystem, Inc., Santa Clara, CA (US)

(21) Appl. No.: 12/179,012

(22) Filed: Jul. 24, 2008

(51) Int. Cl. G11B 33/14

(52) U.S. Cl. 360/97.02

(57) ABSTRACT

Some embodiments of the present invention provide a system that includes a drive carrier for a hard disk drive (HDD) and one or more vibration control clips affixed to the drive carrier. Within this system, a mode of vibration of the HDD is modulated by contact between each of the vibration control clips and a surface within the computer system.

### BACKGROUND

1. Field

Embodiments of the present invention generally relate to techniques for improving performance in hard disk drives (HDDs). More specifically, embodiments of the present invention relate to a method and system for controlling multi-dimensional vibrational modes in HDDs.

2. Related Art

Vibration-related problems are increasingly prominent in high-performance computer systems, such as servers, mainframes, and supercomputers. These vibration-related problems may be caused by several factors. First, cooling fans have become more powerful to compensate for the increased heat generated by the machines' hardware components. In addition, cheaper and more lightweight materials, which are currently used in chassis and support structures, are less effective at dampening vibrations than heavier and more expensive materials. Finally, newer generations of hard disk drives (HDDs) are more sensitive to vibration-induced degradation.

More specifically, HDDs continue to increase in both storage density and performance. At these increased densities, a write head of an HDD may be required to hit a track that is less than 20 nanometers in width. In addition, the write head may be separated from a corresponding platter by a distance of several nanometers. Finally, the platter may be spinning at speeds of up to 15,000 revolutions per minute (rpm). These factors have caused the latest generation of HDDs to be more sensitive to vibrations. Consequently, vibration-related problems may cause the HDDs within a computer system to experience reductions in read and write throughput. Moreover, the increased internal latencies caused by the degraded throughput may cause software applications to hang, crash, and/or reboot.

To compensate for internally excited vibrations from components within the computer system and externally excited vibrations propagated from adjacent systems, designers often apply damping materials, such as rubber grommets, foam composites, and/or elastomeric pads to areas within and/or around the computer system. These damping materials may be placed to mechanically isolate individual HDDs from vibration-generating components within the computer system and from vibrations produced by adjacent systems. However, these damping materials may further limit available space inside densely packed computing systems, impede cooling airflow, and degrade with age.

Furthermore, HDDs from different vendors may be sensitive to different types of vibration and may thus require different types of vibration mitigation features. Hence, alternative methods for controlling vibrations in a variety of HDDs within a computer system may preserve performance and throughput while avoiding problems associated with the use of damping materials.

### SUMMARY

Some embodiments of the present invention provide a system that includes a drive carrier for a hard disk drive (HDD) and one or more vibration control clips affixed to the drive carrier. Within this system, a mode of vibration of the HDD is modulated by contact between each of the vibration control clips and a surface within the computer system.

In some embodiments, each of the vibration control clips includes one or more leaf springs.

In some embodiments, each of the leaf springs modulates a dimension of vibration from the HDD.

In some embodiments, the surface may be a drive slot, a chassis of the computer system, a chassis guide within the computer system, or a housing for the HDD.

In some embodiments, each of the vibration control clips is affixed to a sidewall of the drive carrier.

In some embodiments, each of the vibration control clips is affixed to the drive carrier using a detachable mechanism.

In some embodiments, the mode of vibration is affected by a characteristic of each of the vibration control clips. In these embodiments, the characteristic can be:

(i) a vibration control clip position;

(ii) a vibration control clip size;

(iii) a vibration control clip design; and

(iv) a vibration control clip material.

In some embodiments, the vibration control clip material is steel.

In some embodiments, the mode of vibration is modulated based on at least one of a vibrational sensitivity of the HDD and a chassis of the computer system.

### BRIEF DESCRIPTION OF THE FIGURES

FIG. 1 shows a system for mitigating vibration in a hard disk drive in accordance with an embodiment of the present invention.

FIG. 2A shows a vibration control clip in accordance with an embodiment of the present invention.

FIG. 2B shows a vibration control clip in accordance with an embodiment of the present invention.

FIG. 2C shows a vibration control clip in accordance with an embodiment of the present invention.

FIG. 2D shows a vibration control clip in accordance with an embodiment of the present invention.

FIG. 3 shows a flowchart illustrating the process of mitigating vibration in a computer system in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

Embodiments of the invention provide a method and system for mitigating vibrations experienced by hard disk drives (HDDs). The HDDs may be installed in a computer system such as a personal computer, server, mainframe, and/or supercomputer. Furthermore, the computer system may include HDDs with different sensitivities to vibration. For example, one HDD may be sensitive to high-frequency linear vibration, whereas another HDD may be sensitive to low-frequency rotational vibration.

More specifically, embodiments of the invention provide a method and system for modulating a mode of vibration of an HDD using a set of vibration control clips. The vibration control clips may be affixed to a drive carrier of the HDD. In particular, the vibration control clips may be affixed to a sidewall of the drive carrier. Each vibration control clip may also include one or more leaf springs that are used to modulate vibration by contacting a surface within the computer system. The surface may include a drive slot, the chassis of the computer system, a chassis guide within the chassis, and/or a housing for the HDD.

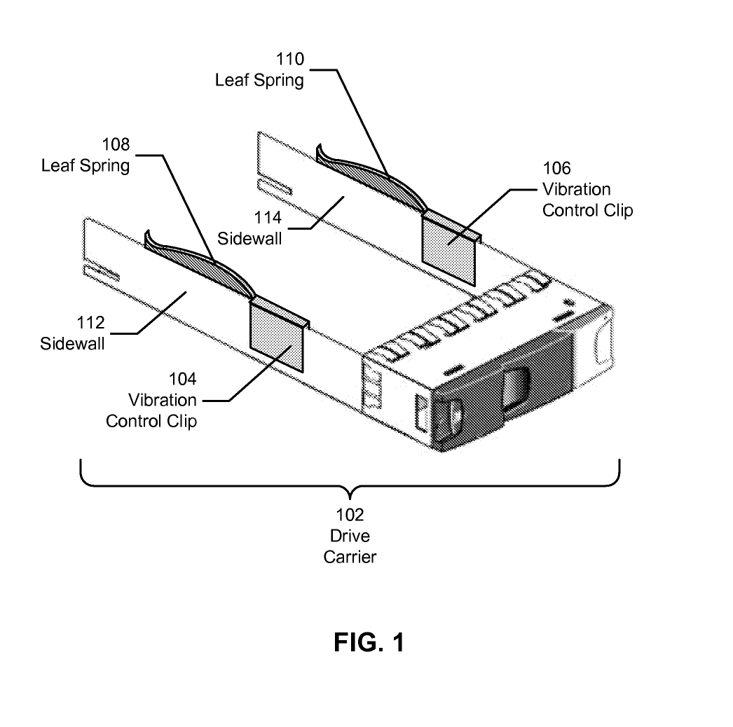

FIG. 1 shows a system for mitigating vibration in a hard disk drive (HDD) in accordance with an embodiment of the present invention. The system includes a drive carrier 102 for the HDD and a set of vibration control clips 104-106 affixed to drive carrier 102. The HDD may be installed into a computer system by placing the HDD into drive carrier 102 and inserting drive carrier 102 into the chassis of the computer system.

The computer system may correspond to a personal computer, a server, a mainframe, a supercomputer, a network attached storage (NAS) system, a storage area network (SAN) system, and/or another electronic computing device. In addition, the HDD may act as a repository for digital files from the computing system, which may be read from, written to, modified, and/or organized by a file system associated with the HDD.

Those skilled in the art will appreciate that the HDD is a precise mechanical and electronic device that operates using closely spaced moving parts. Specifically, the HDD may include one or more rapidly spinning platters and one or more heads. The heads may be used to read from and write to sub-micron-sized regions corresponding to bits on the platters. Furthermore, the heads may be positioned in close proximity to the platters. For example, a high-end HDD may spin at 15,000 revolutions per minute (rpm), use read-and-write heads hovering nanometers from the platters, and store nanometer-sized bits on the platters. Advances in HDD technology may continue to produce HDDs with increasing rotational speed and density. Consequently, forces such as vibrations may adversely affect HDD performance and cause problems with latency and/or application execution.

In particular, HDDs made using different manufacturing processes and/or technologies may be sensitive to different types of vibration. For example, an HDD from one vendor may be sensitive to high-frequency linear vibration, while an HDD from another vendor may be sensitive to high-frequency rotational vibration. Consequently, the chassis of the computer system and/or drive carrier 102 may be unable to accommodate the vibration mitigation requirements of different types of HDDs.

To mitigate vibrations for a variety of HDDs, vibration control clips 104-106 are affixed to drive carrier 102 at positions that modulate a mode of vibration of the HDD. As shown in FIG. 1, vibration control clips 104-106 are affixed to sidewalls 112-114 of drive carrier 102. Each vibration control clip 104-106 further includes a leaf spring 108-110 that is used to modulate the HDD's mode of vibration by contacting a surface within the computer system. The surface may include a drive slot, a chassis of the computer system, a chassis guide within the computer system, and/or a housing for the HDD. For example, vibration control clip 104 may contact a housing for the HDD, while vibration control clip 106 may contact a drive slot, chassis, and/or chassis guide (e.g., guide rail).

Vibration control clips 104-106 may also be affixed to drive carrier 102 using detachable mechanisms. For example, vibration control clips 104-106 may be clipped or snapped into sidewalls 112-114. Alternatively, vibration control clips 104-106 may be screwed into sidewalls 112-114. The detachable nature of vibration control clips 104-106 may allow various types, numbers, and positions of vibration control clips to be used in mitigating vibration for a specific HDD and/or chassis. For example, vibration control clips of a specific design, size, number, placement, and/or material may be used to mitigate vibration in one HDD and/or chassis, while vibration control clips of a different design, size, number placement, and/or material may be used to mitigate vibration in another HDD and/or chassis. As a result, the use of vibration control clips may allow different types and combinations of HDDs to be placed into the computer system by modulating each HDD's mode of vibration according to the HDD's sensitivity to different types of vibration.

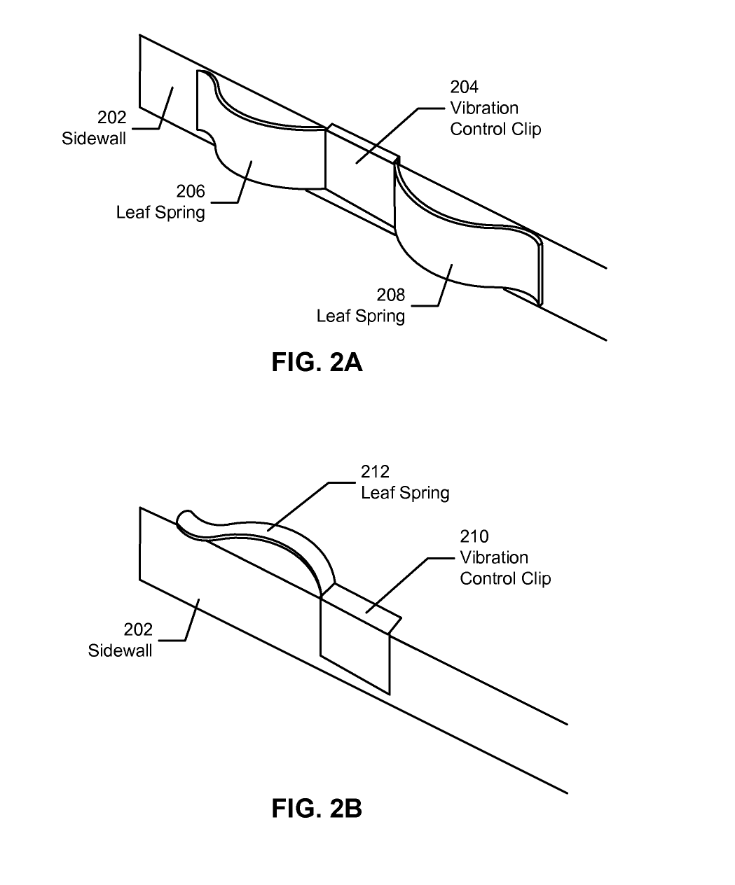

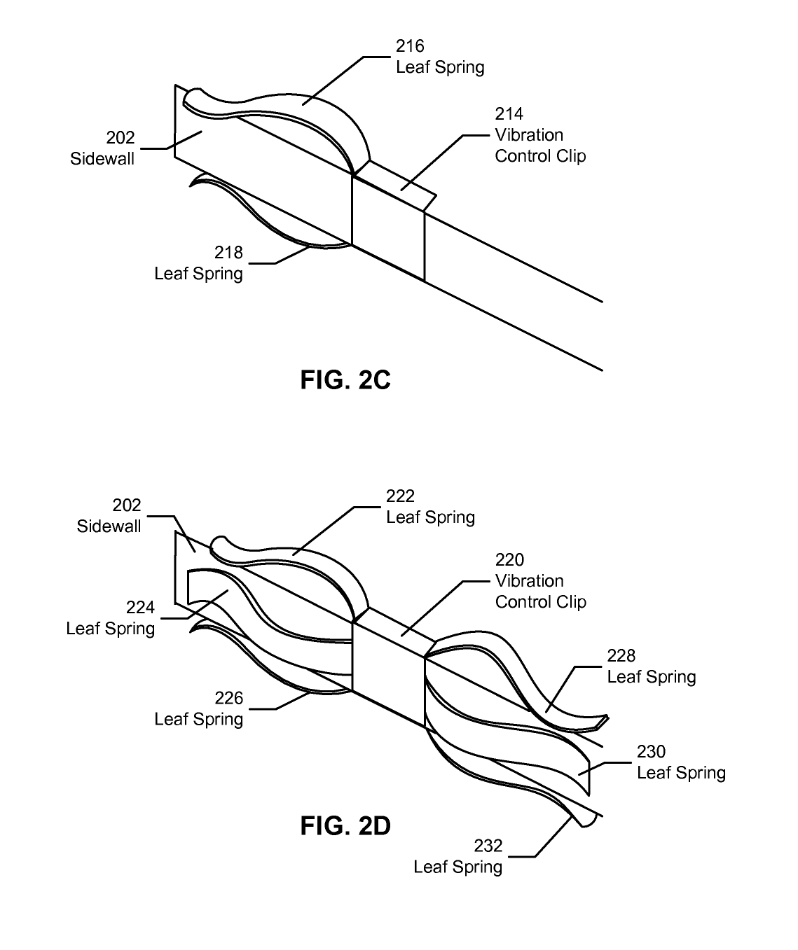

FIG. 2A shows a vibration control clip 204 in accordance with an embodiment of the present invention. As shown in FIG. 2A, vibration control clip 204 is affixed to a sidewall 202 of a drive carrier, such as drive carrier 102 of FIG. 1. Vibration control clip 204 also includes two leaf springs 206-208. Leaf springs 206-208 may contact a surface to the side of sidewall 202, such as a drive slot, chassis, chassis guide, and/or an HDD housing.

In one or more embodiments of the invention, each leaf spring 206-208 is used to modulate a dimension of vibration from an HDD inside the drive carrier and/or a neighboring HDD. More specifically, leaf springs 206-208 may be used to modulate a mode of vibration from the HDD(s) that is roughly perpendicular to the plane created by sidewall 202. In other words, leaf springs 206-208 may mitigate side-to-side vibration experienced by the HDD inside the drive carrier. Furthermore, because vibration control clip 204 includes two leaf springs 206-208, vibration control clip 204 may be used to modulate a different mode of vibration from vibration control clips 104-106 of FIG. 1.

FIG. 2B shows a vibration control clip 210 in accordance with an embodiment of the present invention. As with vibration control clip 204 of FIG. 2A, vibration control clip 210 is also attached to sidewall 202. However, vibration control clip 210 incorporates a design that is different from that of vibration control clip 204. In particular, a leaf spring 212 on vibration control clip is positioned along the top of sidewall 202. As a result, leaf spring 212 may modulate vibration that travels along the plane created by sidewall 202. In other words, leaf spring 212 may modulate vertical vibration experienced by the HDD inside the drive carrier. For example, leaf spring 212 may be used to mitigate vibration in HDDs that are stacked horizontally within a chassis of a computer system. Consequently, leaf spring 212 may contact a surface to the top of sidewall 202, such as an adjacent HDD, a top surface of a drive slot, and/or the chassis of the computer system.

FIG. 2C shows a vibration control clip 214 in accordance with an embodiment of the present invention. Vibration control clip 214 is attached to sidewall 202 of a drive carrier. Furthermore, vibration control clip 214 includes two leaf springs 216-218. More specifically, leaf spring 216 is positioned along the top of sidewall 202, and leaf spring 218 is positioned along the bottom of sidewall 202. As with vibration control clip 210 of FIG. 2B, vibration control clip 214 may be used to mitigate vertical vibrations experienced by the HDD inside the drive carrier.

However, because vibration control clip 214 includes two leaf springs 216-218 positioned along the top and bottom of the drive carrier, vibration control clip 214 may be used to modulate a different mode of vibration from vibration control clip 210. For example, vibration control clip 214 may be used to mitigate vibration in an HDD with a different vibrational sensitivity from that of an HDD that uses vibration control clip 210. Vibration control clip 214 may also be used in a chassis that includes more space between HDDs.

As described above, the mode of vibration may additionally be affected by the size of vibration control clip 214 and/or the material of vibration control clip 214 (e.g., steel, phosphor bronze, titanium, beryllium copper, etc.). For example, a larger, stiffer vibration control clip 214 may be fastened to sidewall 202 to mitigate vibration for parts of the HDD that experience the most vibration (e.g., an unattached end of the HDD). On the other hand, a smaller, softer vibration control clip 214 may be used to mitigate high-frequency vibrations and/or to provide structural support to HDDs that are less sensitive to vibrations.

FIG. 2D shows a vibration control clip 220 in accordance with an embodiment of the present invention. As shown in FIG. 2D, vibration control clip 220 includes six leaf springs 222-232 arranged along the side, top, and bottom of sidewall 202. As a result, vibration control clip 220 may provide vibration mitigation along multiple dimensions of vibration for an HDD within the drive carrier.

Furthermore, the size, material, and/or placement of each leaf spring 222-232 may be varied to allow fine-tuned control of the HDD's mode of vibration. For example, leaf springs 222-226 may be stiffer and/or larger than leaf springs 228-232 to control vibrations near an unattached end of the HDD. Similarly, leaf spring 224 and leaf spring 230 may be softer to control high-frequency side-to-side vibrations experienced by the HDD. Finally, vibration control clip 220 may be positioned along various points on sidewall 202 and in a variety of configurations in conjunction with other vibration control clips (e.g., vibration control clip 204, vibration control clip 210, vibration control clip 214) to provide vibration mitigation along multiple points and dimensions of the HDD and/or neighboring HDDs.

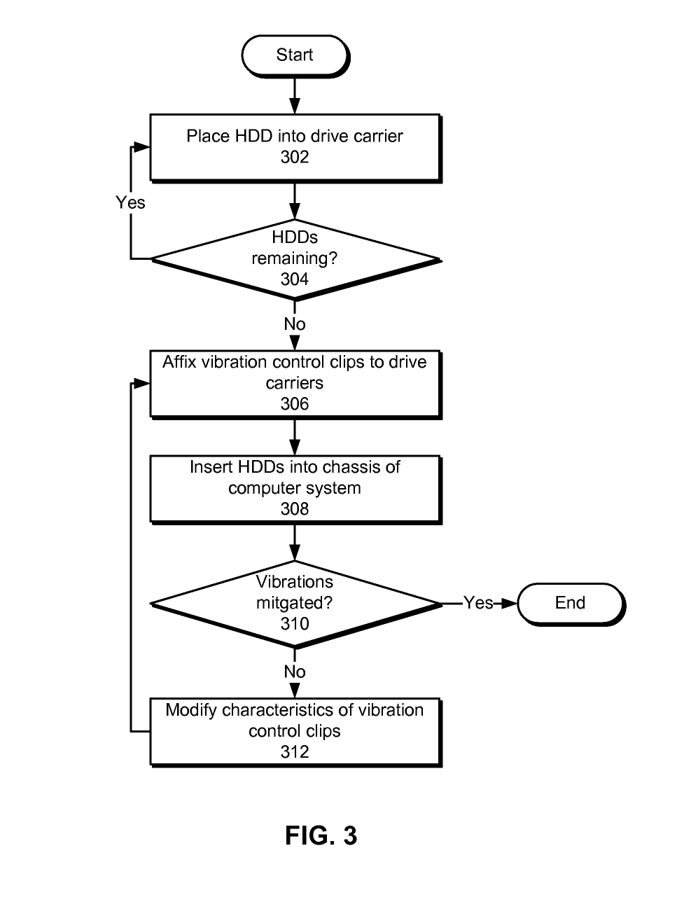

FIG. 3 shows a flowchart illustrating the process of mitigating vibration in a computer system in accordance with an embodiment of the present invention. In one or more embodiments of the invention, one or more of the steps may be omitted, repeated, and/or performed in a different order. Accordingly, the specific arrangement of steps shown in FIG. 3 should not be construed as limiting the scope of the invention.

Initially, a HDD is placed into a drive carrier for the HDD (operation 302). If other HDDs remain (operation 304), each HDD is placed into a corresponding drive carrier until all HDDs are within their respective drive carriers. Multiple HDDs may be placed into drive carriers if the computer system is configured to contain multiple HDDs.

Next, vibration control clips are affixed to the drive carriers for the HDDs (operation 306). More specifically, the vibration control clips may be affixed to the sidewalls of the drive carriers. The vibration control clips may also be affixed using detachable mechanisms to allow additional modifications to be made to better suit the HDDs' sensitivities to different types of vibrations and/or the chassis of the computer system. As discussed above, the vibration control clips may be affixed to the drive carriers based on characteristics such as the positions, sizes, designs, and/or materials of the vibration control clips. Moreover, each HDD's mode of vibration may be affected by the characteristics of the vibration control clip(s) affixed to the HDD's drive carrier and/or to neighboring drive carriers.

The HDDs are then inserted into the chassis of the computer system (operation 308) to allow operation of the computer system and/or HDDs. During operation, the vibrations experienced by the HDDs may be mitigated by the vibration control clips (operation 310) affixed to the HDDs' drive carriers. If the vibrations are mitigated to an acceptable extent, the configuration of HDDs and vibration control clips within the computer system is used during operation of the computer system.

However, if the HDDs are adversely affected by vibrations despite the use of the vibration control clips, the characteristics of the vibration control clips are modified (operation 312). For example, different vibration control clip designs, sizes, numbers, positions, and/or materials may be used in the vibration control clips. The vibration control clips may then be affixed to the drive carriers (operation 306) and the HDDs reinserted into the chassis of the computer system (operation 308) to determine if vibrations are mitigated using the new configuration (operation 310) of vibration control clips. Characteristics of the vibration control clips may continue to be modified (operation 312) until the vibrations experienced by the HDDs are mitigated to an acceptable extent.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A system for mitigating vibration in a hard disk drive (HDD) in a computer system, comprising:
a drive carrier for the HDD; and
one or more vibration control clips affixed to the drive carrier, wherein a mode of vibration of the HDD is modulated by contact between each of the vibration control clips and a surface within the computer system.

2. The system of claim 1, wherein each of the vibration control clips comprises one or more leaf springs.

3. The system of claim 2, wherein each of the leaf springs modulates a dimension of vibration from the HDD.

4. The system of claim 1, wherein the surface is at least one of a drive slot, a chassis of the computer system, a chassis guide within the computer system, and a housing for the HDD.

5. The system of claim 1, wherein each of the vibration control clips is affixed to a sidewall of the drive carrier.

6. The system of claim 1, wherein each of the vibration control clips is affixed to the drive carrier using a detachable mechanism.

7. The system of claim 1, wherein the mode of vibration is affected by a characteristic of each of the vibration control clips, and wherein the characteristic can be:
a vibration control clip position;
a vibration control clip size;
a vibration control clip design; and
a vibration control clip material.

8. The system of claim 7, wherein the vibration control clip material is steel.

9. The system of claim 1, wherein the mode of vibration is modulated based on at least one of a vibrational sensitivity of the HDD and a chassis of the computer system.

10. A method for mitigating vibration in a hard disk drive (HDD) in a computer system, comprising:
placing the HDD into a drive carrier for the HDD;
affixing one or more vibration control clips to the drive carrier; and
inserting the HDD into a chassis of the computer system,
wherein a mode of vibration of the HDD is modulated by contact between each of the vibration control clips and a surface within the computer system.

11. The method of claim 10, wherein each of the vibration control clips comprises one or more leaf springs.

12. The method of claim 11, wherein each of the leaf springs modulates a dimension of vibration from the HDD.

13. The method of claim 10, wherein the surface is at least one of a drive slot, the chassis of the computer system, a chassis guide within the chassis, and a housing for the HDD.

14. The method of claim 10, wherein each of the vibration control clips is affixed to a sidewall of the drive carrier.

15. The method of claim 10, wherein each of the vibration control clips is affixed to the drive carrier using a detachable mechanism.

16. The method of claim 10, wherein the mode of vibration is affected by a characteristic of each of the vibration control clips, and wherein the characteristic can be:
a vibration control clip position;
a vibration control clip size;
a vibration control clip design; and
a vibration control clip material.

17. The method of claim 16, wherein the vibration control clip material is steel.

18. The method of claim 10, wherein the mode of vibration is modulated based on at least one of a vibrational sensitivity of the HDD and a chassis of the computer system.

19. A computer system, comprising:
a processor;
a memory;
a set of drive carriers containing a set of hard disk drives (HDDs); and
a set of vibration control clips affixed to the driver carriers, wherein a mode of vibration of each of the HDDs is modulated by contact between each of the vibration control clips and a surface within the computer system.

20. The computer system of claim 19, wherein the mode of vibration is modulated based on at least one of a vibrational sensitivity of the HDDs and a chassis of the computer system.
